(19) United States
(12) Patent Application Publication
(10) Pub. No.: US 2002/0076296 A1
(43) Pub. Date: Jun. 20, 2002

(54) Torque lock

(76) Inventors: Matthew J. Dunfee, Jordan, MN (US); Donald G. Chase, Jordan, MN (US); David A. Gosewisch, Jordan, MN (US); Donald W. Hegeman, Shakopee, MN (US); David D. Schneider, Hamburg, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/941,152

(22) Filed: Aug. 27, 2001

Related U.S. Application Data
(60) Provisional application No. 60/227,892, filed on Aug. 25, 2000.

(51) Int. Cl. F16B 31/02

(52) U.S. Cl. 411/8

(57) ABSTRACT

A torque lock/indicator including an upper member, and lower member and a compression ring disposed between the upper and lower members. The upper member has at least one extension with an angled contact surface and a locking surface proximate the locking surface. The lower member has an angled, substantially peripheral contact surface and a locking surface proximate the contact surface. An optional cap is provided which is secured to the upper member or the lower member by being interlocked or cemented thereto.

### CROSS-REFERENCE TO RELATED APPLICATIONS

This application claims priority under 35 U.S.C. § 119 (e) to, and hereby incorporates by reference in its entirety, U.S. Provisional Application No. 60/227,892, filed Aug. 25, 2000.

### BACKGROUND OF THE INVENTION

1. Field of the Invention

This invention relates to safety devices and, in particular, this invention relates to devices which ensure that correct torque levels are applied to connectors.

2. Background of the Invention

Ensuring that a correct level of torque is applied to connectors can be of critical importance. One instance where applying the correct level of torque is critically important is when engine oil is changed. Typically, the oil plug is removed from the reservoir drain, the oil is allowed to flow from the reservoir, the oil plug is replaced, and new oil is poured into the engine. Over tightening oil plugs can strip the threads from the reservoir drain, thereby causing oil leakage and engine damage. While torque wrenches can correctly tighten oil plugs, they are seldom used.

Another issue frequently encountered is leakage. After the oil plug has been replaced, oil leaks can arise due to an insufficient seal resulting from improperly tightening the oil plug, from worn components no longer sealing, or from failure to use a seal.

Still another frequently arising issue is prevention and detection of tampering of oil plugs. Often it is desirable to seal the oil plug after an oil change has been performed. Sealing the oil plug serves to deter or detect tampering and can ensure that only authorized persons have serviced the engine.

Oil leaks arising from the above-identified causes leave unsightly and polluting oil spots and cause oil fluid levels to decrease to often dangerously low levels. If detected, low oil levels must be inconveniently replenished. If undetected, low oil levels can cause engine damage or failure.

U.S. Pat. No. 3,595,124, issued to Lindstrand on Jul. 27 1971, discloses a controlled torque bolt having a threaded shank and a driving head identical with and adapted to shear off of the bolt upon the application of a predetermined torque by a driver upon the driving head. Although ensuring that a correct level of torque is applied, once emplaced the bolt conceivably cannot be easily removed. Therefore, the disclosure of this patent is not a feasible solution to the problems disclosed above.

U.S. Pat. No. 4,068,555, issued to Volkman on Jan. 17, 1978, discloses an inherently torque-limited nut, including a nut body having an internal shank-receiving threaded opening to engage a mating thread on a shank. A drive ring is held to the nut body by engagement means and includes inherent limiting means which limit the torque which can be applied to the drive ring by failing at a predetermined torque. However, no known oil reservoirs include this device. Therefore, retrofitting oil reservoirs would be problematic and costly. Moreover, a tamper-proof seal is not disclosed as well.

U.S. Pat. No. 4,408,936, issued to Williamson on Oct. 11, 1983, discloses a torque-limited threaded locking fastener and method for setting the same. The fastener comprises an externally threaded shank and an internally threaded collar. At least one convolution of the threads on the shank is non-circular. The collar has a nut section and a drive section. The driven section is shaped to be engaged by a driver. Between these sections there is formed a shear section having the least torque resistance of the sections. The shear section fractures when a predetermined torque is exerted between the two sections. While ensuring that a predetermine torque will be applied, subsequent removal of the fastener is problematic and there is no provision to prevent or detect tampering.

U.S. Pat. No. 3,434,379, issued to Wing on Mar. 25, 1969, discloses an inherently torque-limited fastener, which has a driving ring that separates from the threaded driven body upon the application of a predetermined torque to the driving ring, thereby leaving the driven body installed at the predetermined torque level. Again, this fastener ensures that a predetermined torque will be applied. However, subsequent removal of the fastener is problematic and there is no provision to detect or deter tampering.

None of the above-discussed documents posits feasible solutions to these problems. There is then a need for a device which will ensure that a correct amount of torque is applied to a fastener, which will provide a fluid tight seal, which can be subsequently be easily removed, and which provides a seal to deter and detect the presence of tampering.

### SUMMARY OF THE INVENTION

This invention substantially meets the aforementioned needs of the industry by providing a torque lock/indicator. An embodiment of the present torque lock/indicator includes an upper member, a compression ring, and a lower member. The upper member has a cylindrical element, three legs depending from the cylindrical element, and a substantially planar element disposed at one end of the cylindrical element. An angled contact surface is present on each leg distal to the attachment of the leg to the cylindrical element and a locking surface near the contact surface is present. The lower member has a structure with a substantially peripheral contact surface and a locking surface proximate the contact surface. The compression ring is disposed between the upper and lower members. The upper member, compression ring, and lower member are configured to axially and rotationally receive a fastener, such as a bolt or an oil plug, therethrough. As the fastener is tightened, the upper member contact surfaces are slidingly displaced against the lower member contact surface and the legs are biased outwardly. When a predetermined level of torque has been applied to the fastener, the upper member contact surfaces have been displaced past the lower member contact surface, thereby allowing the legs to return toward an unbiased position and interlocking the upper and lower members by contacting the upper member and lower member locking surfaces. An optional cap either interlocks with the upper or lower member or is cemented into place. The cap can only be removed by destroying its integrity.

It is an object of this invention to provide a torque indicator to ensure that only a predetermined torque level will be applied to a fastener.

It is another object of this invention to provide a torque indicator which ensures that threaded openings will not be damaged by over tightening of fasteners being threaded therein.

It is still another object of this invention to provide a torque indicator which provides a seal against subsequent fluid leakage or egress.

It is yet still another object of this invention to provide a torque indicator which provides a means of ensuring that threads of openings are functional under known torque levels.

It a feature of the present invention to provide a device which will emit an audible signal when a predetermined amount of torque has been applied to a fastener.

It is another feature of the present invention to provide a device which will visually indicate that a predetermined amount of torque has been applied to a fastener.

It is yet another feature of the present invention to provide a device which will vibrationally indicate that a predetermined amount of torque has been applied to a fastener.

It is still another feature of the present invention to provide a device which includes a seal against fluid loss when the fastener has been threaded into an opening.

These and other objects, features, and advantages of this invention will become apparent from the description which follows, when considered in view of the accompanying drawings.

### BRIEF DESCRIPTION OF THE DRAWINGS

FIG. 1 is an exploded view of a first embodiment of the present torque lock/torque indicator;

FIG. 2 is a top plan view of the fork of the embodiment depicted in FIG. 1;

FIG. 3 is a bottom plan view of the fork of the embodiment depicted in FIG. 1;

FIG. 4 is a cross-sectional view of the fork of FIG. 3 along line F-F;

FIG. 5 is a top plan view of the compression ring of FIG. 1;

FIG. 6 is a cross-sectional view of the compression ring of FIG. 5 along line A-A;

FIG. 7 is a top plan view of the base of FIG. 1;

FIG. 8 is a cross-sectional view of the base of FIG. 7 along line A-A;

FIG. 9 is a magnified view of a portion of the base of FIG. 8 and designated therein as section B;

FIG. 10 is a bottom plan view of the cap of FIG. 1;

FIG. 11 is a cross-sectional view of the cap of FIG. 10 along line A-A;

FIG. 12 is an enlarged view of a second embodiment of the present torque lock torque indicator;

FIG. 13 is a bottom plan view of a third embodiment of the present fork;

FIG. 14 is a cross-sectional view of the fork of FIG. 13 along line C-C;

FIG. 15 is a top perspective view of a fourth embodiment of the present fork;

FIG. 16 a bottom perspective view of the fork of FIG. 15;

FIG. 17 is a top plan view of the fork of FIG. 15;

FIG. 18 is a bottom plan view of the fork of FIG. 15;

FIG. 19 is a cross-sectional view of the fork of FIG. 18 along line F-F;

FIG. 20 is a magnified view of a portion of the fork of FIG. 19 and designated therein as section L;

FIG. 21 is a magnified view of a portion of the fork of FIG. 19 and designated therein as section M; and

FIG. 22 is a magnified view of a portion of the fork of FIG. 19 and designated therein as section K.

It is understood that the above-described figures are only illustrative of the present invention and are not contemplated to limit the scope thereof.

### DETAILED DESCRIPTION OF THE INVENTION/DRAWINGS

Any references to such relative terms as top and bottom, upper and lower, horizontal and vertical, inner and outer, or the like, are intended for convenience of description and are not intended to limit the present invention or its components to any one positional or spatial orientation. All dimensions of the components in the attached figures may vary with a potential design and the intended use of an embodiment of the invention without departing from the scope of the invention.

Representative examples of the teachings of the present invention, which examples utilize many of these additional features and methods in conjunction, will now be described in detail with reference to the drawings. This detailed description is merely intended to teach a person of skill in the art further details for practicing preferred aspects of the present teachings and is not intended to limit the scope of the invention. Therefore, only combinations of features and methods disclosed in the following detailed description may not be necessary to practice the invention in the broadest sense, and are instead taught merely to particularly describe representative and preferred embodiments of the invention.

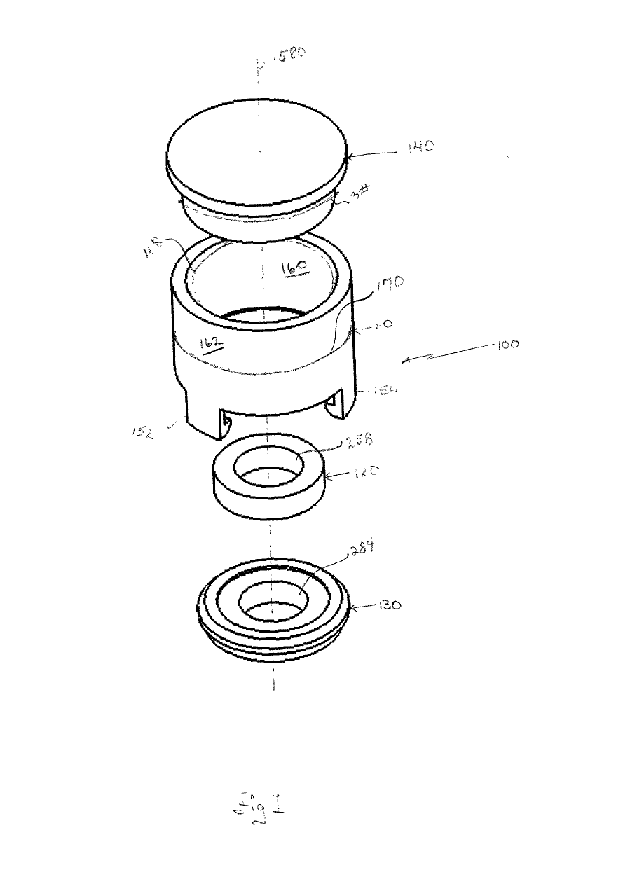

An exploded view of one embodiment of the present torque lock/torque indicator is shown in FIG. 1 generally at 100 and includes an upper member such as a fork 110, a compression member such as a ring 120, a lower member such as a base 130, and an optional tamper proof mechanism such as a cap 140.

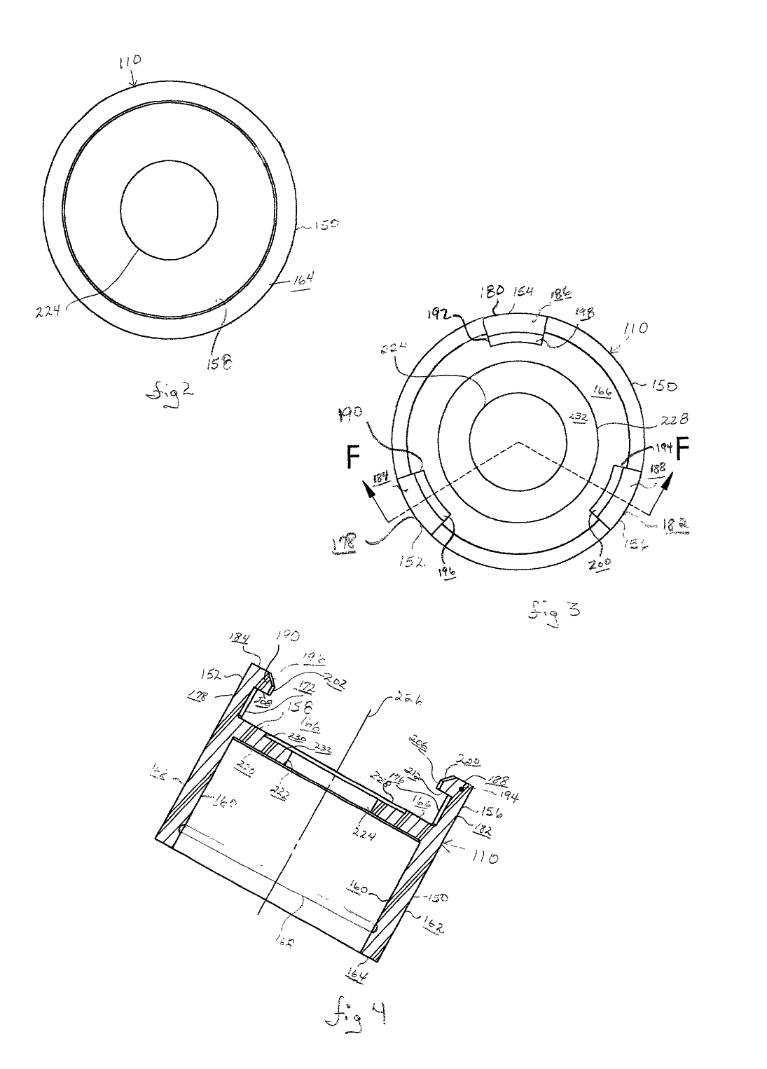

Now referring to FIGS. 1-4, the fork 110 is generally unitary in this embodiment, but may be considered to include a cylindrical element 150, extensions such as legs 152, 154, and 156, and a lower element such as a platform 158. The cylindrical element 150 displays an inner surface 160, an outer surface 162, a top surface 164, and a bottom surface 166. An optional groove 168 is defined in the cylindrical element 150 such that the groove 168 extends from the inner surface 160. An optional score 170 extends inwardly from the outer surface 162, e.g. to a depth of between about 0.030 and 0.035 inch. A score depth of between 60% and 70% of the total thickness has been found to be satisfactory. A depth of 0.050 (+/−0.005) inch has been found to be satisfactory with respect to the groove 168. By way of illustration, and not limitation, this embodiment of the cylindrical element 150 has an outer diameter of 1.3 (+/−0.1) inches, an inner diameter of 1.1 (+/−0.005) inches, and a thickness of 0.1 (+/−0.010) inch.

In this embodiment, the legs 152, 154, and 156 depend (extend) from the cylindrical element 150. The legs 152, 154, and 156 display respective inner surfaces 172, 174 (not shown), 176, outer surfaces 178, 180, 182, and bottom surfaces 184, 186, and 188. Extensions such as lips 190, 192, and 194 extend inwardly from the respective legs 152, 154, and 156. The lips 190, 192, and 194, in turn, display respective contact surfaces 196, 198, and 200, inner surfaces 202, 204 (not shown), and 206 and lower surfaces 208, 210 (not shown), and 212. With respect to leg 152 and without limitation (legs 154 and 156 being substantially identical in this embodiment), the distance between surfaces 208 and 166 is 0.275 (+/−0.005) inch, the distance between inner and outer surfaces 172 and 178 is about 0.070 (+/−0.005) inch. Concerning lip 190 and without limitation (lips 192 and 194 being substantially identical in this embodiment), the distance between surfaces 178 and 202 is about 0.145 (+/−0.005) inch, the distance between surfaces 208 and 184 is 0.075 (+/−0.001) inch, the distance from the intersection of surfaces 196 and 202 to the intersection of surfaces 202 and 208 is 0.025 (+/−0.005) inch, and the contact surface 196 is angled from the lower surface 184 by 45 (+/−1.5, 2.5, 5.0) degrees. The legs 152, 154, and 156 and lips 190, 192, and 194 are equidistantly spaced, occupy arcs of about 30 (+/−1.5, 2.5, 5.0) degrees, and are hence separated by arcs of 90 (+/−1.5, 2.5, 5.0) degrees. The legs 152, 154, and 156 may unitarily extend from the cylindrical element 150 such that the leg outer surfaces 178, 180, and 182 are continuous with the cylindrical element outer surface 162.

In this embodiment, the platform 158 extends inwardly from the cylindrical element 150 and displays respective upper and inner surfaces 220 and 222. The bottom surface of the platform 158 is coextensive with the bottom surface 166 of cylindrical element 150. The platform inner surface 222 coaxially defines a bore 224 about an axis 226. A recess 228 is defined by inner surface 230 and lower surface 232. The recess 228 may have a depth of about 0.020 (+/−0.005) inch and a diameter of 0.82 (+/−0.005) inch. The distance between the surfaces 166 and 220 may be about 0.010 (+/−0.005) inch.

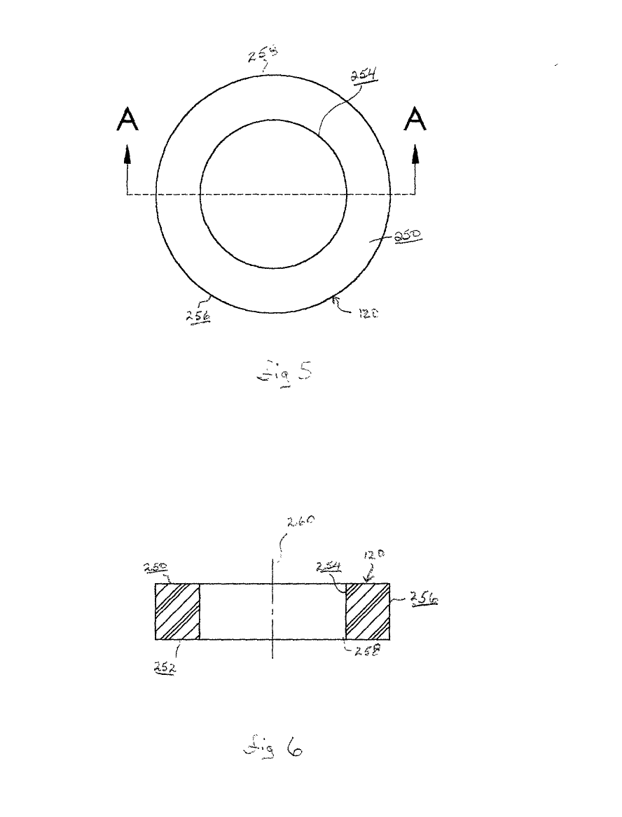

Referring now to FIGS. 1, 5, and 6, the exemplary compression ring 120 displays respective upper, lower, inner, and outer surfaces 250, 252, 254, and 256. The compression ring inner surface 254 coaxially defines a bore 258 about an axis 260. By way of illustration and not limitation, the diameter of the compression ring is 0.8 (+/−0.005) inch and the diameter of the bore 258 is about 0.5 (+/−0.005) inch. The distance between the upper and lower surfaces 250 and 252, hence the thickness, of the compression ring 120 is 0.19 (+/0.01) in this embodiment, although the dimensions of the present compression ring may be determined by such factors as the dimensions of the device, the preset torque level, and the type of materials from which the present compression ring is made. The compression ring 120 is dimensioned to be accommodated in the platform recess 288.

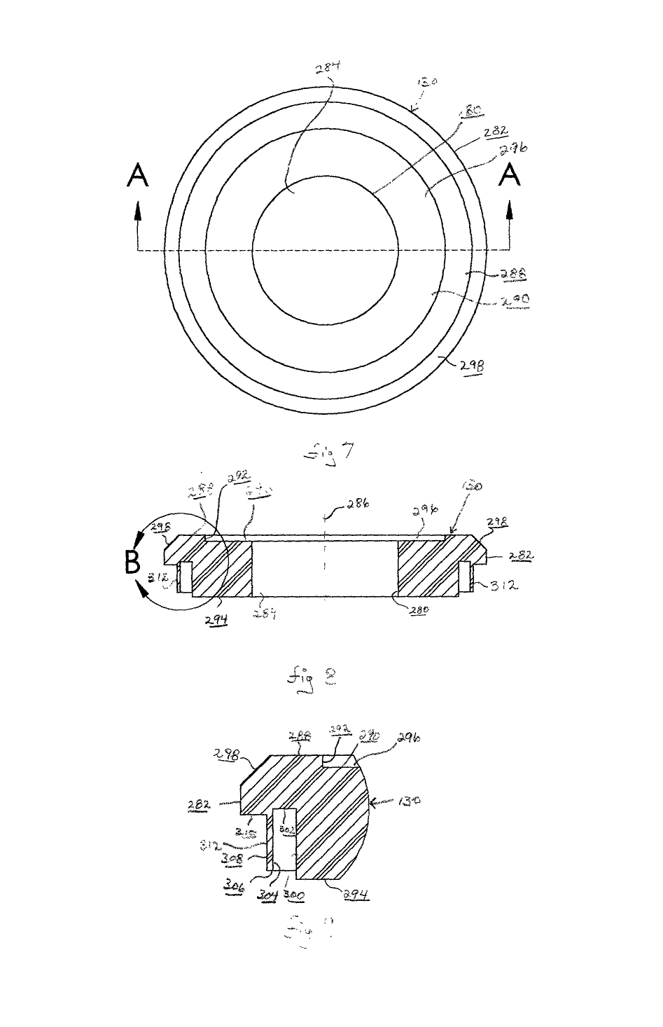

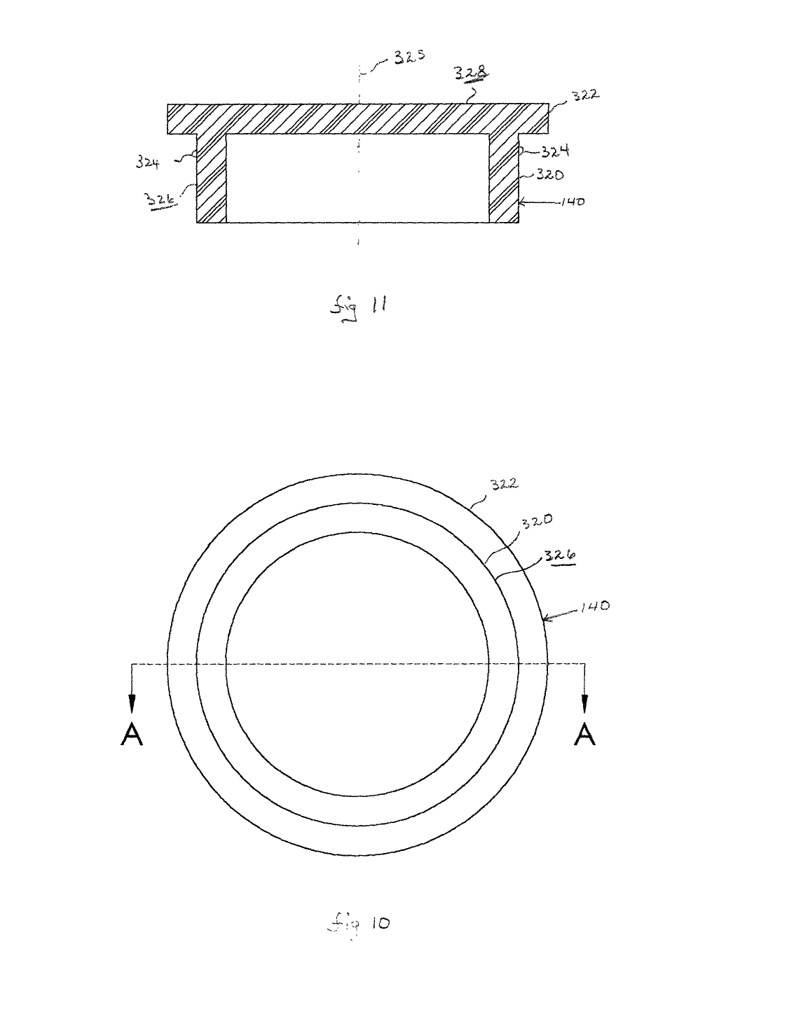

FIGS. 1, 7, 8, and 9 depict the exemplary base 130. The base 130 displays a first inner surface 280 and a first outer surface 282. The first outer surface 282 may be about 0.050 (+/0.001) in height. The outer surface 282 coaxially defines a bore 284 about an axis 286. The base 130 further defines respective first and second upper surfaces 288 and 290, a surface 292 extending generally perpendicularly (or otherwise transversely) between the upper surfaces 288 and 290, and a first lower surface 294. In one embodiment, the distance between surfaces 288 and 294, hence the thickness of this portion of the base 130, is 0.225 (+/−0.005) inch. The upper and transverse surfaces 290 and 292 define a recess 296. The recess may have a diameter of about 0.82 (+/−0.005) inch and a depth of about 0.020 (+/−0.005). The recess 296 may be substantially identical to the platform recess 228 and is dimensioned to accommodate the compression ring 120 therewithin. A contact surface 298 extends between the upper surface 288 and the outer surface 282. In this embodiment, the contact surface 298 is angled from the upper surface 288 by 45 (+/−1.5, 2.5, 5.0) degrees. The contact surfaces 196 and 298 may be angled to a greater or lesser extend depending on factors such as the materials from which the present fork and base are made and the preset torque level. A second outer surface 300 perpendicularly (or other wise transversely) extends between the first lower surface 294 and a second lower surface 302. A second inner surface 304 extends perpendicularly (or otherwise transversely) between the second lower surface 302 and a third lower surface 306. A third outer surface 308 extends perpendicularly (or otherwise transversely) between the third lower surface 306 and a fourth lower surface 310. The fourth lower surface perpendicularly (or otherwise transversely) intersects the first outer surface 282. The second inner surface 304, the third lower surface 306, and the third outer surface 308 define a contact element 312. As can be best seen in FIG. 9, the second lower surface 302 is generally higher than (offset from) the fourth lower surface 310 by about 0.010 (+/−0.005) inch. The contact element 312 is separated from the main portion of the base 132 by about 0.040 (+/−0.005) inch, is offset from the outer surface 282 by about 0.045 (+/−0.005) inch, and depends from the main portion of the base 130 by a length of about 0.095 (+/−0.005) inch in this embodiment. The bottom surface 306 may be offset about 0.030 (+/−0.005) inch. As will be explained more fully below the contact element 312 may have other dimensions depending on factors such as the desired pitch and volume of sound to be emitted and properties (e.g., resilience, weight) of the materials from which it is made.

As shown in FIGS. 10 and 11, the exemplary cap 140 unitarily includes a cylindrical element 320 and a top element 322 coaxially disposed about an axis 323. The cylindrical element 320 has a bead 324 extending from an exterior surface 326. The bead 324 is sized and dimensioned to be accommodated in the groove 168 of the fork cylindrical element. Moreover, the cylindrical element 320 is dimensioned to fit snugly into the fork cylindrical element 150. By way of illustration and not limitation, the top element 322 displays a top surface 328, is 0.100 (+/−0.010) inch in thickness, and 1.300 (+/−0.005) inches in diameter. The cylindrical element 320 has a height of 0.3 (+/−0.010) inch, an inner diameter of 0.9 (+/0.010), an outer diameter of 1.1 (+/−0.005) inch, and a thickness of 0.1 (+/−0.05) inch.

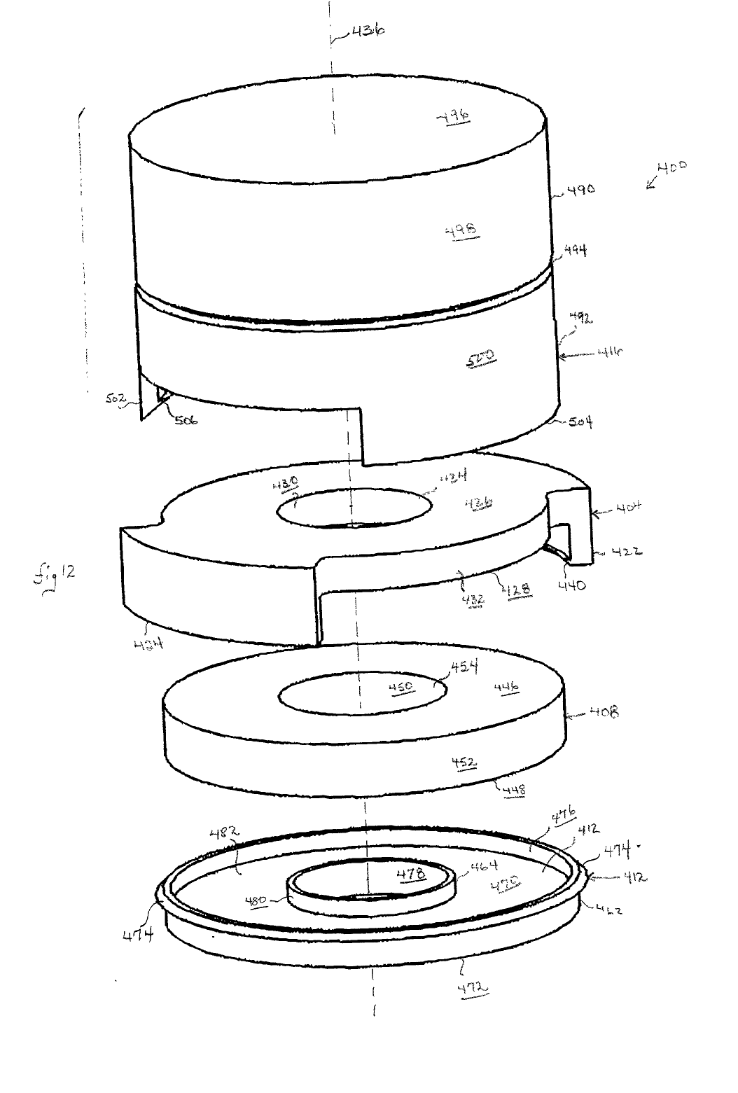

A second embodiment of the present torque lock/torque indicator is depicted in FIG. 12 at 400 and includes an upper member such as fork 404, a compression member such as ring 408, a lower member such as a base 412, and a tamper preventive device such as cap 416.

The exemplary fork 404 has a generally central disk element 420 and a pair of oppositely disposed legs 422 and 424. The desk element 420 displays an upper surface 426, a lower surface 428, an inner surface 430, and an outside surface 432. The inner surface 430 coaxially defines a bore 434 about an axis 436. Respective lips 440 and 442 (not shown) extend from the legs 422 and 424. Contact surfaces, such as described above, are present on the lips 440 and 442. A recess may be defined proximate the lower surface 428 and may be dimensioned to accommodate the ring 408, as more fully described above with respect to the ring 120.

One embodiment of the present compression ring is shown at 408. The compression ring 408 displays an upper surface 446, a lower surface 448, an inner surface 450, and an outer surface 452. The inner surface defines a bore 454 coaxially about the axis 436.

Exemplary base 412 includes a disk element 460, an outer rim 462, and an inner rim 464. The disk element 460 displays respective upper and lower surfaces 470 and 472. The outer rim 462 terminates in a contact surface 474. The contact surface 474 and the contact surface of the lips 440 and 442 may be configured similarly, or substantially identically, to the contact surfaces described with respect to the embodiment 100, above. The outer rim displays an inner surface 476. The inner rim 464 displays respective inner and outer surfaces 478 and 480. The inner surface 476, the upper surface 470, and the outer surface 480 define a recess 482. The recess 482 is a dimensioned to accommodate the compression ring 408. The inner rim inner surface 478 coaxially defines a bore 484 about the axis 436.

The exemplary cap 416 has an upper portion 490 and a lower portion 492, the upper and lower portions separated at a score 494. In one embodiment, the score 494 is about 0.050 (+/0.005) inch in depth. The upper portion 490 displays an upper surface 496 and an outer surface 498. The lower portion 492 displays an outer surface 500. A pair of legs 502 and 504 depend from the lower portion 492. Respective lips 506 and 508 (not shown) extend inwardly from the legs 502 and 504 and include contact surfaces as discussed above with respect to the contact surfaces of the first embodiment fork.

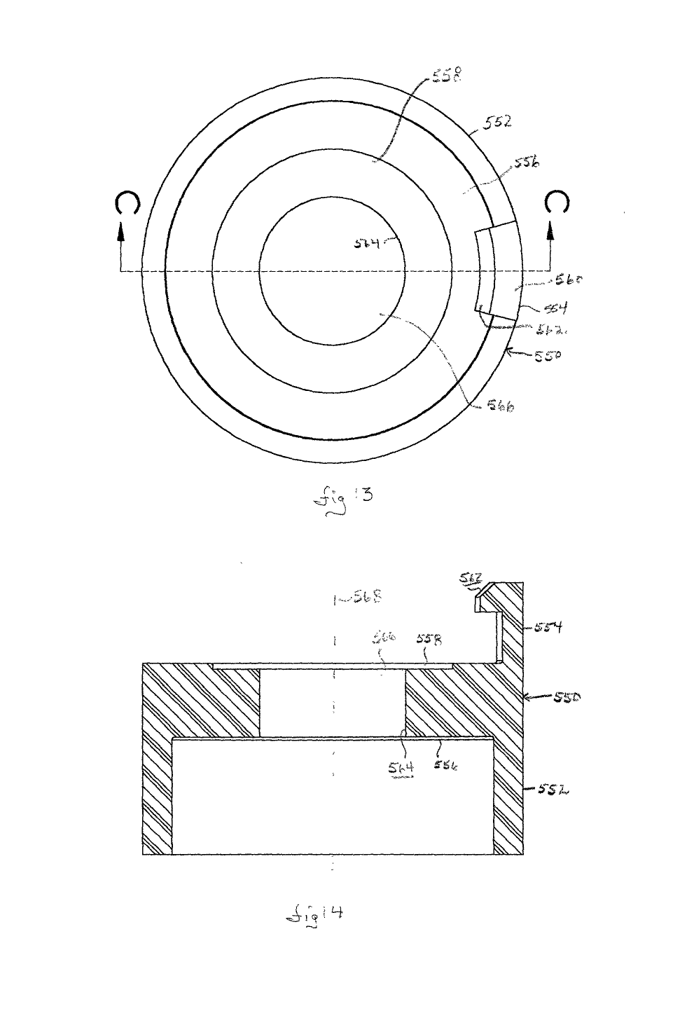

A third embodiment of the present upper member is depicted in FIGS. 13 and 14 as fork 550. The fork 550 unitarily includes a cylindrical element 552, a leg 554, and a platform 556. The cylindrical element 552 and the platform 556 may be similar, or substantially identical, to similar elements described with respect to embodiment 100, above. A recess 558 may be formed in the platform 556 as described above with respect to embodiment 100, as well. The leg 554 includes a lip 560 with a contact surface 562. While the lips 560 and contact surface 562 may be similar, or substantially identical, to similarly named elements of embodiment 100 as discussed above, the leg 554 is between 50% and 75% longer than the legs of previous embodiments. As in previously discussed embodiments, an inner surface 564 of the platform 556 coaxially defines a bore about an axis 568.

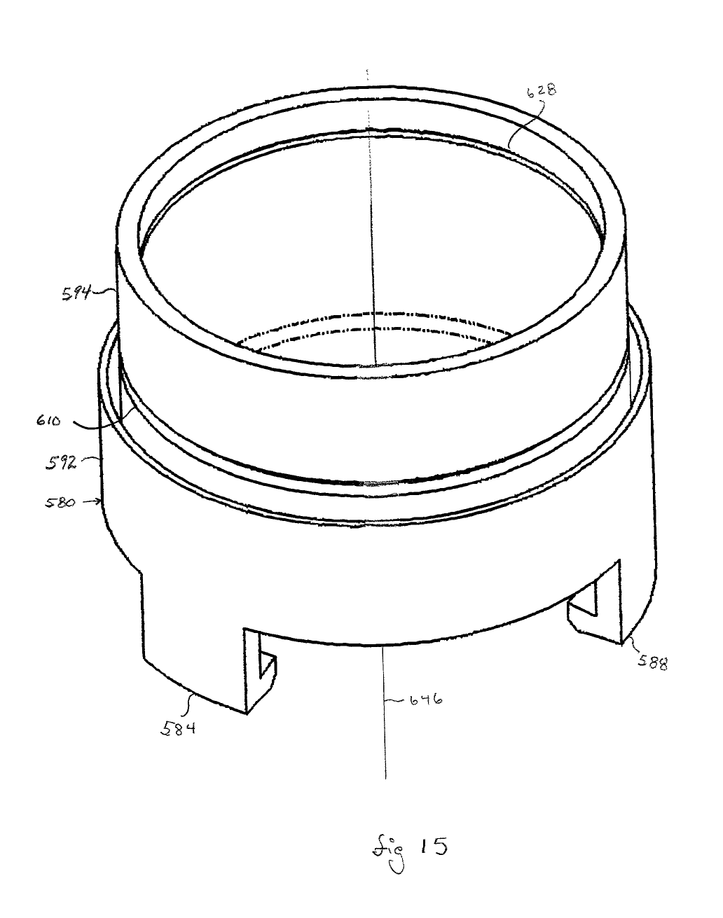

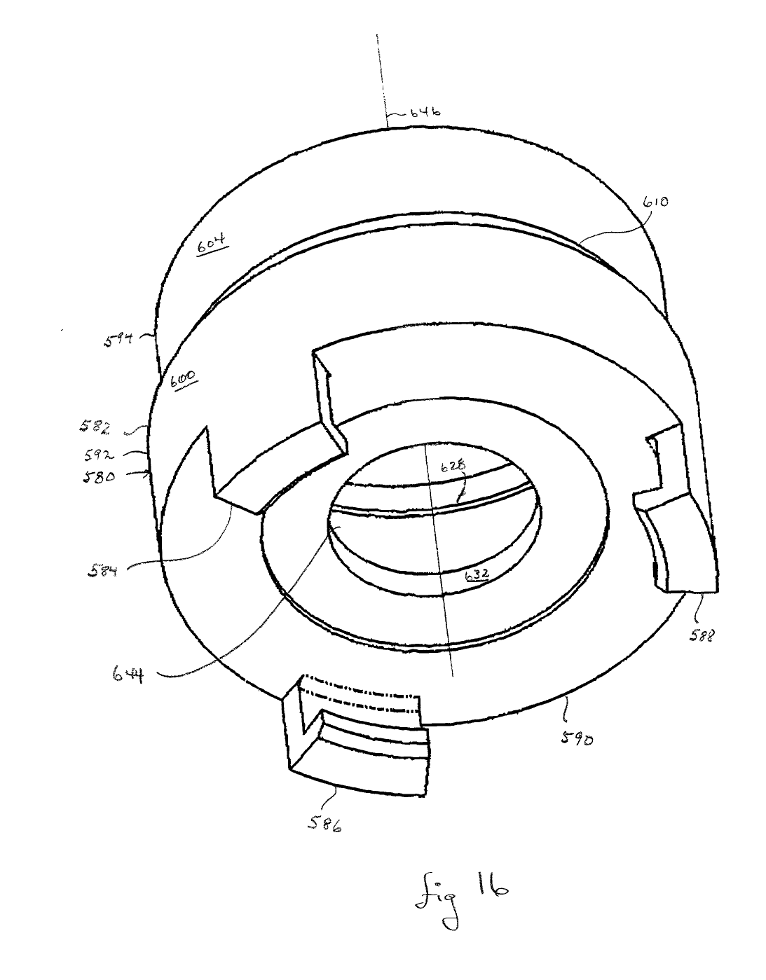

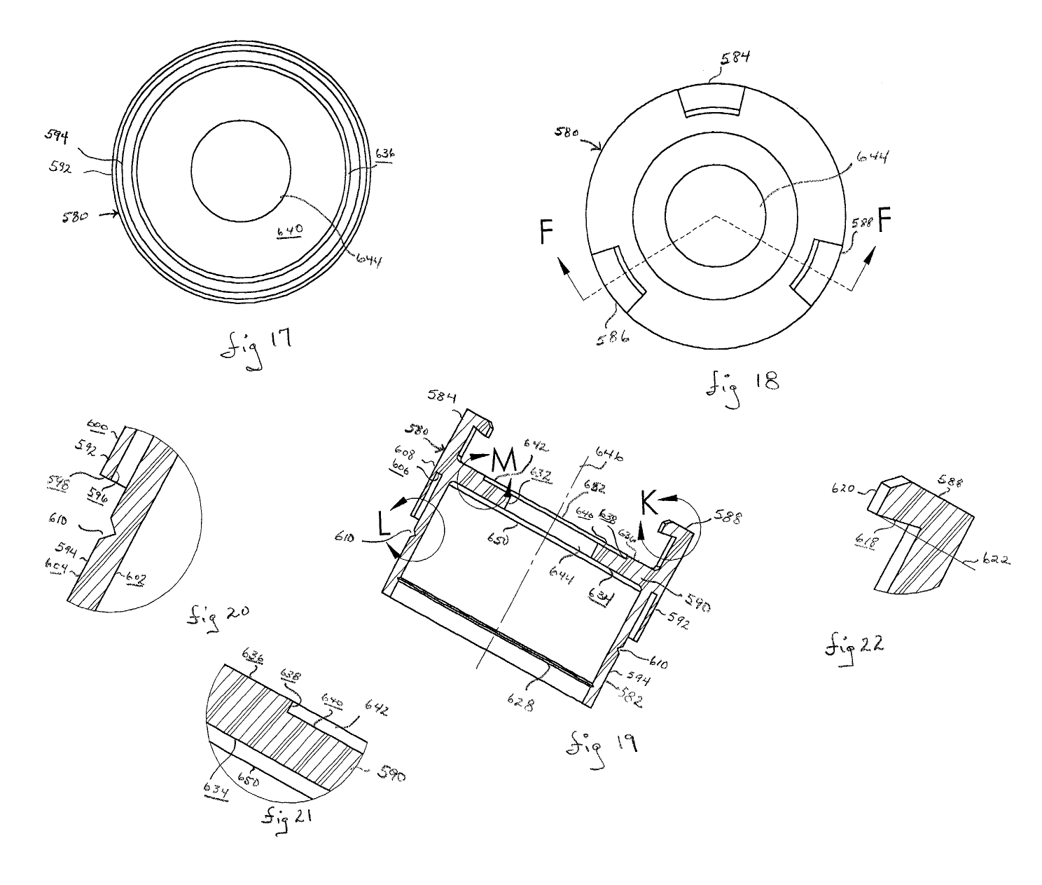

An exemplary fourth embodiment of the present upper member is depicted in FIGS. 15-22 as fork 580. The fork 580 is substantially unitary in this embodiment, but may be considered to include cylindrical element 582, extensions such as legs 584, 586, and 588, and a lower element such as a platform 590.

One difference between the cylindrical element 582 and other embodiments discussed above is the presence of an outer portion 592 and an inner portion 594. In this embodiment, the outer and inner portions are coaxial. The outer portion 592 displays respective inner, upper, and outer surfaces 596, 598, and 600. The inner portion 594 displays respective inner and outer surfaces 602 and 604. A second upper surface 606 is displayed on a base 608 of the fork 580 and spans between the outer portion 592 and the inner portion 594. The distance between upper surfaces 598 and 606, hence the length of the outer portion 592, may be about 0.725 (+/−0.005) inch. The distance between the inner and outer surfaces 596 and 600, hence the thickness of the outer portion 592, may be about 0.020 (+/−0.005) inch and the distance between the inner and outer surfaces 602 and 604, hence the thickness of the inner portion 594, may be about 0.050 (+/0.005) inch. The inner portion 594 and outer portion 592 may be separated by a gap of 0.030 (+/−0.05) inch. A groove is defined in inner portion 594 and may extend from the outer surface 604 thereof to a depth between about 0.030 and 0.035 inches or to a depth of between about 60% and 70% of the total thickness of the inner portion 594.

Another difference is the conformation of the legs 584, 586, and 588. Without limitation and referring to the leg 588 (legs 584 and 586 being substantially identical in this embodiment), an upper surface 618 of lip 620 thereof, is angled from a horizontal orientation 622 by 12 (+/−0.5, 1.0, 1.5) degrees.

A groove 628 is defined in the inner portion 594 and may extend from the inner surface 602 to a depth of 0.1 (+/−0.01) inch. The platform 590 displays an inner surface 632, an upper surface 634, a first lower surface 636, a second inner surface 638, and a second lower surface 640. The second inner surface 638 and the second lower surface define a recess 642. The recess 642 may be substantially similar, or identical, to the other recesses of this invention in dimension and function. The first inner surface 632 coaxially defines a bore 644 about an axis 646. An angular or arcuate portion such as fillets 650 and 652 may be present where the platform surfaces join the cylindrical element inner surface. Moreover, similar angular or arcuate portions may be present at any place where surfaces would otherwise angularly join in the devices of this invention.

The compression ring of the present invention may be made from synthetic resins such as polyurethane. Properties of a suitable polyurethane include a tensile break of 7500 psi, a 100% modulus of 5500 psi, an elongation of 225%, a compression set as determined by Method A (at 70 degrees Celsius) of 15%, a Shore Durometer of 75D, tear properties (pli, Die C) of 850, a Tabor abrasion resistance (H18 at 1000 gm load, mg loss/1000 cycles) of 450, a specific gravity of 1.18, and an ether base. One suitable polyurethane is marketed by Minnesota Plastics, Eden Prairie, Minn. as MP175™.

The other components can be constructed from materials such as synthetic resins as well. Two suitable synthetic resins suitable for this purpose are known as glass-fiber-reinforced nylon 6/6 and nylon 6/6. The glass-fiber-reinforced nylon 6/6 may be a 30% glass-fiber-reinforced nylon 6/6 with a density of 0.0488 lb/cu. in., a specific gravity of 1.35, a water absorption (24 hours at 73 degrees Fahrenheit) of 0.7%, a tensile strength (at 73 degrees Fahrenheit) of 27,000 psi, an elongation (at 73 degrees Fahrenheit) of 3%, a flexural strength (at 73 degrees Fahrenheit) of 39,100 psi, a flexural modulus (at 73 degrees Fahrenheit) of 12×10⁵ psi, a Rockwell hardness of M101, an Izod impact strength (notched at 73 degrees Fahrenheit) of 2.1 ft-lb/in, a thermal deflection temperature at 66 psi of 490 degrees Fahrenheit, a thermal deflection temperature at 264 psi of 482 degrees Fahrenheit, a maximum temperature (long term) of 230 degrees Fahrenheit, a maximum temperature (short term) of 465 degrees Fahrenheit, a coefficient of linear thermal expansion (−20 degrees −200 degrees Fahrenheit) of 1.2×10⁻⁵ in/in/degree Fahrenheit, a dielectric strength of 530 V/mil, a dielectric constant (60 Hz, 73 degrees Fahrenheit, 50% RH) of 3.5, and an electrical volume resistivity (73 degrees Fahrenheit) of 10¹⁵ ohm cm. One suitable glass-fiber-reinforced nylon 6/6 is marketed by Minnesota Plastics, Eden Prairie, Minn. as ENSILON™ 6/6 GF30.

The nylon 6/6 may have a density of 0.0412 lb/cu. in., a specific gravity of 1.14, a water absorption (24 hours at 73 degrees Fahrenheit) of 8.5%, a tensile strength (at 73 degrees Fahrenheit) of 12,400 psi, an elongation (at 73 degrees Fahrenheit) of 90%, a flexural strength (at 73 degrees Fahrenheit) of 17,000 psi, a flexural modulus (at 73 degrees Fahrenheit) of 4.1×10⁵ psi, a Rockwell hardness of R120-M79, an Izod impact strength (notched at 73 degrees Fahrenheit) of 1.2 ft-lb/in, a thermal deflection temperature at 66 psi of 455 degrees Fahrenheit, a thermal deflection temperature at 264 psi of 194 degrees Fahrenheit, a maximum temperature (long term) of 2170 degrees Fahrenheit, a maximum temperature (short term) of 355 degrees Fahrenheit, a coefficient of linear thermal expansion (−20 degrees −200 degrees Fahrenheit) of 4.5×10⁻⁵ in/in/degree Fahrenheit, a coefficient of linear thermal expansion (200 degrees −460 degrees Fahrenheit) of 5.0×10⁻⁵ in/in/degree Fahrenheit, a dielectric strength of 600 V/mil, a dielectric constant (60 Hz, 73 degrees Fahrenheit, 50% RH) of 4.0, and an electrical volume resistivity (73 degrees Fahrenheit) of 10¹⁵ ohm cm. One suitable nylon 6/6 is marketed by Minnesota Plastics, Eden Prairie, Minn. as ENSILON™ 6/6.

Persons of ordinary skill in the art will also readily comprehend that such factors as thicknesses, lengths, and materials can be routinely altered to provide desired sound pitches and amplitudes and to accommodate any desired predetermined torque level. While utility with oil plugs is described, the present torque lock/indicator is obviously suitable for several uses. While cross-sectional geometries depicted have been predominantly circular, persons of ordinary skill in the art will readily recognize that other cross-sectional geometries may be suitable in other embodiments of this invention.

Functionally, the present torque lock/torque indicator may be assembled for convenience into substantially two components. The first component would include the fork 110, compression ring 120, and base 130 adheringly assembled. One procedure would include cementing (or otherwise adhering) the fork 110 to the upper surface of the compression ring 120 and the base 130 to the lower surface of the compression ring 120. The fork 110, compression ring 120, and base 130 would be assembled such the axes 226, 260, and 286 are aligned as indicated at 580 in FIG. 1. Similarly and referring to FIG. 12, the fork lower surface 428 would be adhered to the disk element upper surface 446 and the disk element lower surface 448 would be adhered to the surface 470 of the base 412.

In use and referring to FIGS. 1-11, a connector (such as an oil drain plug) is inserted through bores 224, 258 and 284 and such that the connector head contacts the platform upper surface 220 of the fork 110 and such that the fork contact surfaces 196, 198, and 200 contact the base contact surface 298. The connector may snugly fit within the bores 224, 258, and 284. The connector is then threaded, e.g., into the drain, and tightened to a desired, predetermined torque level. Upon attaining the predetermined torque level, the legs 152, 154, and 156 are displaced downwardly (from an unbiased position toward a biased position) until the fork contact surfaces 196, 198, and 200 slip past the base contact surface 298, slightly angling the leg ends (e.g., surfaces 184, 186, and 188) outwardly. Tightening the connector further compresses the compression ring 120 and displaces the leg inner surfaces 202, 204, and 206 past the base contact surface 298. Continuing to tighten the connector still further compresses the compression ring 120, to allow the legs to return to (or toward) their previous, generally vertical (unbiased) positions and interlocks the fork 110, compression ring 120, and base 130 together by abutting surfaces 208, 210, and 212 against the surface 310 of the base 130. The legs 152, 154, and 156 return to their previous, generally vertical positions very quickly and with considerable force, thereby generating and an audible sound in one embodiment. The sound is believed to be generated as surfaces 202, 204, and 206 forcefully strike the base surface 308, thereby vibrating the contact element 312. In one embodiment, the connector has been tightened to a predetermined torque level. However, in another embodiment, the connector is then rotated one-fourth of a turn to arrive at the predetermined torque level.

In the embodiment represented by FIGS. 15-22, the angled lip upper surface 618 functions to eliminate, or minimize, friction-generating contact between the lip upper surface 618 and the lower surface 310 of the base 130. Otherwise, the force at which the legs return toward an unbiased position would be somewhat dissipated by the friction between the lip upper surface and the base lower surface. Therefore, the force with which the contact element would be impacted by the lip surface would be diminished as well and the resulting sound would be lower in magnitude.

Referring further to the embodiment represented by FIGS. 15-22, the outer portion 592 of the cylindrical element 582 further amplifies the sound emitted when the extension lips strike the base contact element. It is believed that the impact of the lips striking the base contact element causes both the cylindrical element outer portion and contact element to vibrate, thereby amplifying the sound generated.

In addition to the audible indicator, the outward, then inward displacement of the legs is a visual indicator that the predetermined, desired torque level has been attained. Moreover, the vibration occurring when the sound is generated can also be felt by the person tightening the connector. Thus, the person tightening the connector is alerted audibly, usually, and by feel, that the desired torque level has been attained. Obviously, operating the torque lock 400 of FIG. 12 and the fork 550 would be substantially identical, or similar, and the same sensory indicators would indicate that the desired, predetermined torque level has been achieved. It is contemplated that the present base, when secured as described above, will also provide a fluid-tight seal. This sealing feature of the present base is especially advantageous when the present device is used to ensure that oil drain plugs are tightened at proper torque levels.

Once the desired torque level has been attained, one of caps 140 or 416 may be used to prevent the connector from being loosened or otherwise tampered with. Referring to FIG. 1, the cylindrical element 320 of the cap 140 is pressed into cylindrical element 150 of the fork 110 until the bead 324 is disposed in the grooves 168, thereby securing the cap 140 in place. Additionally, the cap 140 can be further secured within the fork 110 by using an adhesive, such as cement or a solvent such as acetone. Referring to FIG. 12, the contact surfaces of the cap 416 are pressed against the contact surfaces of the base 412, then further pressed, thereby flexing the legs outwardly, then still further pressed until the legs straighten as explained above. The caps are thusly locked into place and cannot be removed without being destroyed. The presence of intact caps locked or cemented into place indicates that the assembly has not been tampered with and the connector is in place at the desired torque.

When it is desired to remove the connector, the upper portion of the cap can be grasped, e.g., with pliers, and separated from the upper portion of the cap by breaking the cap along the score 494. Alternatively, a hammer can be used to break the cap, either method allowing access to the connector for removal.

When used as described herein, the present torque lock/indicator allows connectors to be tightened to a desired, predetermined torque level and secured against further tightening or tampering. The present torque lock/indicator thus protects the threads in components such as oil pans from being overstressed, stretched and stripped out when connectors are being tightened therein. Moreover, the present torque lock/indicator provides a seal against fluid egress. The presence of the secured caps further ensures that the seal is in place, thus further preventing fluid egress or loss. Another advantage of the present torque lock/indicator is that threads of components are examined for integrity as connectors are tightened therein to desired, preset torque levels.

Because numerous modifications of this invention may be made without departing from the spirit thereof, the scope of the invention is not to be limited to the embodiments illustrated and described. Rather, the scope of the invention is to be determined by the appended claims and their equivalents.

What is claimed is:

1. A torque indicator, comprising:
an upper member including an upper member extension, the upper member extension displaying an upper member contact surface;
a lower member with a lower member extension, the lower member extension displaying a lower member contact surface; and
a compression member, configured to be disposed between the upper member and the lower member,
the upper member, the lower member and the compression member accommodating a threaded connector therethrough,
the upper member and lower member matable, wherein the upper member contact surface slidingly contacts the lower member contact surface, the upper member contact surface displaced relative to the lower member contact surface and the upper member extension biased outwardly when the connector is rotated, the upper member contact surface displaced past the lower member contact surface thereby generating a sound and the upper member extensions returning to an unbiased position when the connector has been rotated to a predetermined torque level.

2. The torque indicator of claim 1, the upper member including a plurality of upper member extensions.

3. The torque indicator of claim 1, the upper member including at least three upper member extensions.

4. The torque indicator of claim 1, the upper member including a generally cylindrical element and a lower element disposed within the cylindrical element, the lower member extension depending from the cylindrical element.

5. The torque indicator of claim 1,
the upper member including a plurality of upper member extensions, each upper member extension displaying an upper member locking surface,
the lower member displaying a lower member locking surface,
the upper member locking surface and the lower member locking surface lockingly contacting when the connector has been rotated to the predetermined torque level.

6. The torque indicator of claim 5, the upper member defining an upper member recess, the lower member defining a lower member recess, the upper member recess and the lower member recess configured to accommodate the compression member therebetween.

7. The torque indicator of claim 6, in which the lower element disposed within the cylindrical element contacting the connector when the connector is rotated.

8. The torque indicator of claim 6, in which the lower element disposed within the cylindrical element is substantially planar.

9. The torque indicator of claim 1, the lower member further comprising a contact element, the contact element emitting a sound when impacted by the upper member extension when the upper member extension returns to the unbiased position.

10. The torque indicator of claim 9, the contact element disposed proximate a lower periphery of the lower member.

11. The torque indicator of claim 1, further comprising a cap, the cap matable to the upper member or the lower member.

12. A torque indicator, comprising:
an upper member including a generally cylindrical element and a plurality of upper member extensions depending from the cylindrical element, each of the plurality of upper member extensions with an angled upper member contact surface;
a lower member with a peripheral angled lower member contact surface, the lower member contact surface contacting the upper member contact surfaces when the upper member and the lower member are mated; and
a compression ring operably disposable between the upper member and lower member,
the upper member, the compression ring, and the lower member axially accommodating a connector therethrough.

13. The torque indicator of claim 12, further comprising a cap matable to one of the upper member or the lower member.

14. The torque indicator of claim 12, further comprising a cap, the cap irreversibly matable to the upper member.

15. The torque indicator of claim 12, further comprising a cap, the cap irreversibly matable to the lower member.

16. A process of exerting a predetermined torque level on a connector, comprising:
providing a torque indicator with a first member, a second member and a compression ring disposed between the first member and second member, the first member having a plurality of first member extensions, each first member extension displaying an angled contact surface, the second member displaying an angled, substantially peripheral contact surface contacting each first member contact surface;
axially extending the connector through the first member, compression ring, and second member;
threading the connector into a threaded opening;
exerting a first torque level on the connector, thereby sliding each first member contact surface against the second member contact surface, and outwardly biasing each first member extension;
exerting the predetermined torque level on the connector, thereby sliding each first contact member contact surface past the second member contact surface and moving each first member extension into a locking position, thereby generating a sound and interlocking the first and second members.

17. The process of claim 16, in which the connector is threaded into an oil pan.

18. The process of claim 16, further comprising connecting a cap to the first member or the second member.

19. The process of claim 17, further comprising interlocking a cap to the first member or the second member.

20. The process of claim 17, further comprising cementing a cap to the first member or the second member.
